(19) United States
(12) Patent Application Publication
(10) Pub. No.: US 2018/0245674 A1
(43) Pub. Date: Aug. 30, 2018

(54) Hydraulic Speed Ratio Control Method for Vehicles with a Ball Variator Continuously Variable Transmission

(71) Applicant: DANA LIMITED, MAUMEE, OH (US)

(72) Inventors: Jeffrey M. DAVID, CEDAR PARK, TX (US); Stijn GOOSSENS, ERPE-MERE (BE); Gordon M. MCINDOE, VOLENTE, TX (US); T. Neil MCLEMORE, GEORGETOWN, TX (US); Matthew SIMISTER, AUSTIN, TX (US); Gregory G. STEVENSON, AUSTIN, TX (US); Mark R. J. VERSTEYHE, OOSTKAMP (BE); Thomas J. VYNCKE, DEINZE (BE)

(21) Appl. No.: 15/751,219

(22) PCT Filed: Aug. 8, 2016
(86) PCT No.: PCT/US16/46029

§ 371 Date: Feb. 8, 2018

Related U.S. Application Data
(60) Provisional application No. 62/203,787, filed on Aug. 11, 2015.
(60) Provisional application No. 62/220,510, filed on Sep. 18, 2015.

(51) Int. Cl. F16H 15/50; F16H 61/664; F16H 61/30; F16H 63/06; F16H 61/00

(52) U.S. Cl. CPC F16H 15/503; F16H 61/664; F16H 61/0021; F16H 63/065; F16H 61/30

(57) ABSTRACT

This invention relates to controlling the speed ratio of a Continuous Variable Transmission with a hydraulic method. The Ball Planetary CVT design is adapted with a mechanical and hydraulic addition. The carrier of the ball-type variator is supported by hydraulic actuators. The result is that the speed ratio is controlled by both a set speed ratio and the torque flowing through the CVT. Subsequently, torque peaks are avoided and controllability of the CVT is increased.

### CROSS-REFERENCES TO RELATED APPLICATIONS

The present application claims the benefit of U.S. Provisional Patent Application No. 62/203,787, filed Aug. 11, 2015 and U.S. Provisional Patent Application No. 62/220,510, filed Sep. 18, 2015, which applications are incorporated herein by reference.

### BACKGROUND OF THE INVENTION

Automatic and manual transmissions are commonly used in the automotive market. Those transmissions have become more and more complicated since the engine speed has to be properly adjusted to improve fuel economy and minimize the emissions. This finer control of the engine speed in conventional transmissions is typically done by adding extra gears but with increased overall complexity and cost. Thus, the number of gears for a usual manual transmission became six, seven or more for automatic transmissions.

In addition to these more conventional transmissions, Continuously Variable Transmissions (CVT) have been developed. CVTs are of many types including: belts with variable pulleys, toroidal, conical, etc. The main working principle of a CVT is that it enables the engine to run at its most efficient rotation speed by steplessly changing the transmission ratio as a function of the vehicle speed. Moreover, the CVT also shifts to a ratio providing more power if higher acceleration is needed. A CVT changes the ratio from the minimum to the maximum ratio without any interruption of power, unlike conventional transmissions which cause an interruption of power during ratio shifts. A specific use of CVTs is the Infinite Variable Transmission (IVT). Whereas the CVT is limited at positive speed ratios, the IVT configuration performs a neutral gear and even reverse ratios continuously. A CVT is optionally used as an IVT in some driveline configurations. However there are still limitations regarding torque peaks and controllability of the speed ratio of the CVT in a number of different applications. Thus there is a need for an improved method of control.

### SUMMARY OF THE INVENTION

Provided herein is a shift actuator assembly for a continuously variable planetary transmission having a plurality of tiltable balls coupled to a first carrier member and a second carrier members, the first carrier member adapted to rotate with respect to the second carrier member, the shift actuator assembly comprising: a hydraulic actuator operably coupled to the second carrier member, the hydraulic actuator comprising a first electronic proportional valve, the electronic proportional valve configured to control the relative position of the second carrier member with respect to the first carrier member.

In some embodiments, the shift actuator assembly further comprises a second electronic proportional valve, wherein the first and second electronic proportional valves are configured to control the relative position of the second carrier member with respect to the first carrier member.

In some embodiments, the shift actuator assembly further comprises a first hydraulic piston and a first cylinder assembly operably coupled to the second carrier member.

In some embodiments of the shift actuator assembly, further comprising a second hydraulic piston and second cylinder assembly, the first and second hydraulic piston and first and second cylinder assemblies are in fluid communication with the first and second electronic proportional valves.

In some embodiments of the shift actuator assembly, the first and second hydraulic piston and first and second cylinder assemblies are configured to provide opposing force on the second carrier member.

In some embodiments of the shift actuator assembly, the relative position of the second carrier member with respect to the first carrier member corresponds to a speed ratio condition of the transmission.

In some embodiments of the shift actuator assembly, the first and second electronic proportional valves are configured to provide a hydraulic pressure to the first and second hydraulic piston and the first and second cylinder assemblies, the hydraulic pressure being indicative of the operating condition of the transmission.

In some embodiments of the shift actuator assembly, the operating condition of the transmission is the speed ratio or a CVP output torque.

Provided herein is a method of controlling a speed ratio of a continuously variable planetary transmission having a plurality of tiltable balls coupled to a first carrier member and a second carrier members, the first carrier member adapted to rotate with respect to the second carrier member, the method comprising: providing a hydraulic valve assembly having a plurality of control valves; and coupling the hydraulic valve assembly to the second carrier member, wherein the hydraulic valve assembly is configured to control the relative rotation of the second carrier member with respect to the first carrier member.

Provided herein is a computer-implemented system for a shift actuator assembly of a continuously variable transmission having a ball-planetary variator (CVP) having a plurality of tiltable balls coupled to a first carrier member and a second carrier members, wherein the first carrier member is adapted to rotate with respect to the second carrier member, the shift actuator assembly comprising: a hydraulic actuator operably coupled to the second carrier member, the hydraulic actuator comprising a first electronic proportional valve and a second electronic proportional valve configured to control the relative position of the second carrier member with respect to the first carrier member, the computer-implemented system comprising: a digital processing device comprising an operating system configured to perform executable instructions and a memory device; a computer program including instructions executable by the digital processing device to create an application comprising a software module configured to manage the first electronic proportional valve and the second electronic proportional valve; a plurality of sensors comprising: a first carrier position sensor, a second carrier position sensor, a first electronic pressure sensor in hydraulic communication with the first electronic proportional valve, a second electronic pressure sensor in hydraulic communication with the second electronic proportional valve, a CVP input speed sensor, a CVP output speed sensor and a CVP speed ratio sensor; the plurality of sensors configured to monitor continuously variable transmission parameters comprising: a first carrier position, a second carrier position, a first pressure in hydraulic communication with the first electronic proportional valve, a second pressure in hydraulic communication with the second electronic proportional valve, a CVP input speed, a CVP output speed and a CVP speed ratio; wherein the software module receives data from the plurality of sensors and executes instructions to manage a controlled activation of the first and second electronic proportional valves; wherein the software module commands the first and second electronic proportional valves to deliver a target hydraulic pressure; wherein the software module monitors the CVP speed ratio; and wherein the software module commands a change in the first carrier position with respect to the second carrier position of the CVP based at least in part on the speed ratio of the CVP.

In some embodiments of the computer implemented system, the CVP speed ratio is determined based at least in part on a CVP output speed sensor.

In some embodiments of the computer implemented system the first carrier position with respect to the second carrier position is indicative of the CVP speed ratio.

Provided herein is a hydraulic actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the hydraulic actuator assembly comprising: a manifold body adapted to receive a pressurized fluid; a solenoid valve coupled to the manifold body; and a spool housed and supported in the manifold body; wherein the manifold body is configured to route the pressurized fluid to the solenoid valve and the spool; and wherein the manifold body is hydraulically coupled to at least one carrier member.

In some embodiments, the hydraulic actuator comprises a first pressure cylinder, a second pressure cylinder, and a control piston, wherein the first pressure cylinder and the second pressure cylinder are arranged to exert a fluid pressure on each side of the control piston.

In some embodiments of the hydraulic actuator, the control piston is operably coupled to at least one carrier member.

In some embodiments of the hydraulic actuator, a movement of the control piston corresponds to a rotation of the carrier member.

In some embodiments of the hydraulic actuator, a plurality of drain channels are in fluid communication with the spool and the solenoid valve.

Provided herein is a hydraulic actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the hydraulic actuator assembly comprising: a manifold body adapted to receive a pressurized fluid; a first solenoid valve coupled to the manifold body; and a second solenoid valve coupled to the manifold body; wherein the manifold body is adapted to route the pressurized fluid to the first solenoid valve and the second solenoid valve; and wherein the manifold body is provided with a first outlet port and a second outlet port, the first outlet port in fluid communication with the first solenoid valve, the second output port in fluid communication with the second solenoid valve; and wherein the first and second outlet ports are hydraulically coupled to at least one carrier member.

In some embodiments of the hydraulic actuator, a first pressure cylinder, a second pressure cylinder, and a control piston are arranged to exert a fluid pressure on each side of the control piston.

In some embodiments of the hydraulic actuator, the control piston is operably coupled to at least one carrier member.

In some embodiments of the hydraulic actuator, a movement of the control piston corresponds to a rotation of the carrier member.

Provided here in is a shift actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the shift actuator assembly comprising: a hydraulic actuator operably coupled to at least one carrier member, the hydraulic actuator comprising a first electronic proportional valve, the first electronic proportional valve configured to control the relative position of the second carrier member with respect to the first carrier member; and a damping device operably coupled to at least one carrier member, the damping device configured to adjust the reaction torque on the at least one carrier member during operation of the transmission.

In some embodiments of the hydraulic actuator, the damping device comprises a first spring, the first spring coupled to the carrier member and to a grounded member.

In some embodiments of the hydraulic actuator, the damping device further comprises a second spring coupled to the carrier member, the second spring coupled to the first spring, the first spring having a first spring rate, the second spring having a second spring rate.

In some embodiments of the hydraulic actuator, the damping device comprises a spring with an adjustable pre-load.

Provided herein is a computer-implemented system for a shift actuator assembly of a continuously variable transmission having a ball-planetary variator (CVP) having a plurality of tiltable balls coupled to a carrier assembly, the carrier assembly having a first carrier member and a second carrier member, wherein the first carrier member is adapted to rotate with respect to the second carrier member, the system comprising: a hydraulic actuator operably coupled to at least one carrier member, the hydraulic actuator comprising at least one electronic valve configured to control the relative position of the second carrier member with respect to the first carrier member, the computer-implemented system comprising: a digital processing device comprising an operating system configured to perform executable instructions and a memory device; a computer program including instructions executable by the digital processing device to create an application comprising a software module configured to manage the at least one electronic valve; a plurality of sensors comprising: a first carrier position sensor, a second carrier position sensor, a first electronic pressure sensor in hydraulic communication with the first electronic proportional valve, a second electronic pressure sensor in hydraulic communication with the second electronic proportional valve, a CVP input speed sensor, a CVP output speed sensor and a CVP speed ratio sensor; the plurality of sensors configured to monitor continuously variable transmission parameters comprising: a first carrier position, a second carrier position, a first pressure in hydraulic communication with the first electronic proportional valve, a second pressure in hydraulic communication with the second electronic proportional valve, a CVP input speed; and a CVP output speed, wherein the software module receives data from the plurality of sensors and executes instructions to manage a fluid supply pressure to the at least one electronic valve; wherein the software module commands the at least one electronic valve to deliver a commanded pressure; wherein the software module monitors a CVP speed ratio; and wherein the software module commands a change in the first carrier position with respect to the second carrier position of the CVP based at least in part on the speed ratio of the CVP. Provided herein is a computer-implemented system for a shift actuator assembly of a continuously variable transmission having a ball-planetary variator (CVP) having a plurality of tiltable balls coupled to a carrier assembly, the carrier assembly having a first carrier member and a second carrier member, wherein the first carrier member is adapted to rotate with respect to the second carrier member, the system comprising: a hydraulic actuator operably coupled to at least one carrier member, the hydraulic actuator comprising an electronic valve configured to control the relative position of the second carrier member with respect to the first carrier member, the computer-implemented system comprising: a digital processing device comprising an operating system configured to perform executable instructions and a memory device; a computer program comprising the instructions executable by the digital processing device to create an application comprising a software module configured to manage the electronic valve; a plurality of sensors comprising: a first carrier position sensor, a second carrier position sensor, an electronic pressure sensor in hydraulic communication with the electronic valve, a CVP input speed sensor, a CVP input speed sensor and a CVP output speed sensor; the plurality of sensors configured to monitor continuously variable transmission parameters comprising: a first carrier position, a second carrier position, a pressure in hydraulic communication with the electronic valve, a CVP input speed; and a CVP output speed, wherein the software module receives data from the plurality of sensors and executes the instructions to control a fluid supply pressure to the electronic valve; wherein the software module commands the electronic valve to operate at the pressure; wherein the software module monitors a CVP speed ratio based on the CVP input speed and the CVP output speed; and wherein the software module commands a change in the first carrier position with respect to the second carrier position of the CVP based at least in part on the speed ratio of the CVP. In some embodiments, the software module further comprises a damping control sub-module configured to control the fluid supply pressure based at least in part on a desired damping of the CVP. In some embodiments the desired damping of the CVP is based at least in part on a torque input to the CVP. In some embodiments, the software module further comprises a calibration table storing values of a commanded hydraulic pressure based at least in part on the torque input.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member used in the variator of FIG. 1.

FIG. 3 is an illustrative view of different tilt positions of the ball-type variator of FIG. 1.

FIG. 4 is a block diagram of a basic driveline configuration of a continuously variable transmission (CVT) used in a vehicle.

FIG. 5 is a schematic view of a shift actuator assembly having a hydraulic actuator.

FIG. 6 is another schematic view of the shift actuator assembly of FIG. 5.

FIG. 7 is a schematic view of a hydraulic shift actuator having a single solenoid valve.

FIG. 8 is a schematic view of a hydraulic shift actuator having a dual solenoid valve.

FIG. 9 is a block diagram of a transmission control system having active damping control.

FIG. 10 is a schematic view of a hydraulic shift actuator having passive damping control.

FIG. 11 is a schematic view of a hydraulic shift actuator having another passive damping control system.

FIG. 12 is a schematic view of a carrier member provided with a damping control system.

FIG. 13 is a schematic view of spring arrangements for passive damping control systems.

FIG. 14 illustrates charts of carrier position versus reaction torque for a number of damping control systems.

### DETAILED DESCRIPTION OF THE INVENTION

This invention relates to controlling the speed ratio of a Continuous Variable Transmission with a hydraulic method. The Ball Planetary CVT design is adapted with a hydraulic addition. The carrier of the ball-type variator is supported by hydraulic actuators. The result is that the speed ratio is controlled by both a set speed ratio and the torque flowing through the CVT. Subsequently, controllability of the CVT is increased.

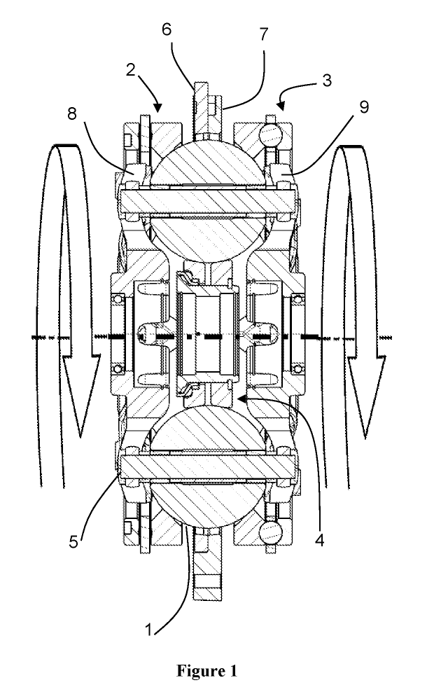

A typical ball planetary variator CVT design, such as that described in U.S. Patent Publication No. 2008/0121487 and in U.S. Pat. No. 8,469,856, both incorporated herein by reference, represents a rolling traction drive system, transmitting forces between the input and output rolling surfaces through shearing of a thin fluid film. The technology is called Continuously Variable Planetary (CVP) due to its analogous operation to a planetary gear system. The system consists of an input disc (ring) driven by the power source, an output disc (ring) driving the CVP output, a set of balls fitted between these two discs and a central sun, as illustrated in FIG. 1. The balls are able to rotate around their own respective axle by the rotation of two carrier disks at each end of the set of balls axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention can include several novel features, no single one of which is solely responsible for its desirable attributes or which is essential to practicing the inventions described.

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input 2 and output 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 9 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier members to impart a tilting of the axles 5 and thereby adjusts the speed ratio of the variator. Other types of ball CVTs also exist, like the one produced by Milner, but are slightly different.

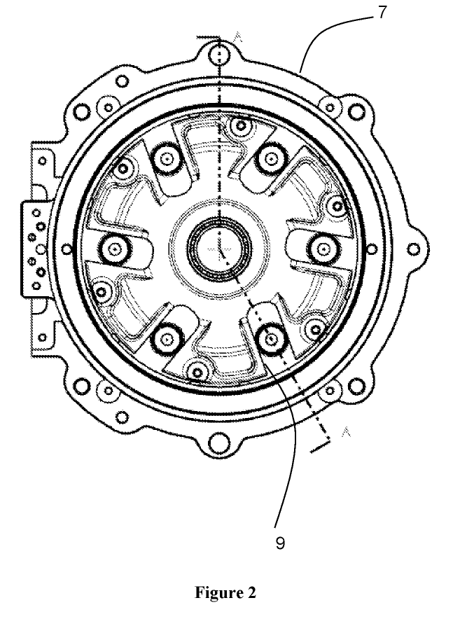

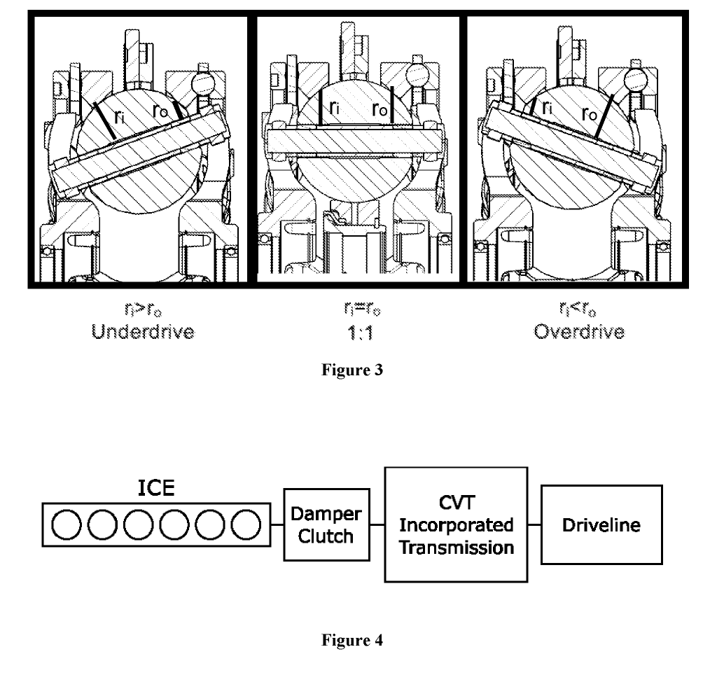

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

Upon reading this disclosure, one skilled in the art will recognize that the present invention includes a continuously variable transmission that may be employed in connection with any type of machine that is in need of a transmission. For example, the transmission may be used in (i) a motorized vehicle such as an automobile, motorcycle, ATV, utility, hybrid or watercraft, (ii) a non-motorized vehicle such as a bicycle, tricycle, exercise equipment or (iii) industrial equipment, such as an end mill, lathe, drill press, pumps, power generating equipment, paper or textile mill to name a few machines that utilize transmissions.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor can read information from, and write information to, the storage medium. In the alternative, the storage medium may be integral to the processor. The processor and the storage medium may reside in an ASIC. For example, in some embodiments, a controller for use of control of the IVT comprises a processor (not shown).

Referring now to FIG. 4, in some embodiments, a vehicle is equipped with a driveline having a torsional damper between an engine and an infinitely or continuously variable transmission (CVT) to avoid transferring torque peaks and vibrations that could damage the CVT (called variator or CVP in this context as well). In some configurations this damper also is optionally configured to be coupled with a clutch for the starting function or to allow the engine to be decoupled from the transmission. Other types of CVT's (apart from ball-type traction drives) are also used as the variator in this layout. In addition to the configurations above where the variator is used directly as the primary transmission, other architectures are possible. Various powerpath layouts are optionally introduced by adding a number of gears, clutches and simple or compound planetaries. In such configurations, the overall transmission provides several operating modes; a CVT, an IVT, a combined mode and so on. A control system for use in an infinitely or continuously variable transmission will now be described.

Provided herein is a shift actuator assembly for a continuously variable planetary transmission having a plurality of tiltable balls coupled to a first carrier member and a second carrier members, the first carrier member adapted to rotate with respect to the second carrier member, the shift actuator assembly comprising: a hydraulic actuator operably coupled to the second carrier member, the hydraulic actuator comprising a first electronic proportional valve, the electronic proportional valve configured to control the relative position of the second carrier member with respect to the first carrier member.

In some embodiments, the shift actuator assembly further comprises a second electronic proportional valve, wherein the first and second electronic proportional valves are configured to control the relative position of the second carrier member with respect to the first carrier member.

In some embodiments, the shift actuator assembly further comprises a first hydraulic piston and a first cylinder assembly operably coupled to the second carrier member.

In some embodiments of the shift actuator assembly, further comprising a second hydraulic piston and second cylinder assembly, the first and second hydraulic piston and first and second cylinder assemblies are in fluid communication with the first and second electronic proportional valves.

In some embodiments of the shift actuator assembly, the first and second hydraulic piston and first and second cylinder assemblies are configured to provide opposing force on the second carrier member.

In some embodiments of the shift actuator assembly, the relative position of the second carrier member with respect to the first carrier member corresponds to a speed ratio condition of the transmission.

In some embodiments of the shift actuator assembly, the first and second electronic proportional valves are configured to provide a hydraulic pressure to the first and second hydraulic piston and the first and second cylinder assemblies, the hydraulic pressure being indicative of the operating condition of the transmission.

In some embodiments of the shift actuator assembly, the operating condition of the transmission is the speed ratio or a CVP output torque.

Provided herein is a method of controlling a speed ratio of a continuously variable planetary transmission having a plurality of tiltable balls coupled to a first carrier member and a second carrier members, the first carrier member adapted to rotate with respect to the second carrier member, the method comprising: providing a hydraulic valve assembly having a plurality of control valves; and coupling the hydraulic valve assembly to the second carrier member, wherein the hydraulic valve assembly is configured to control the relative rotation of the second carrier member with respect to the first carrier member.

Provided herein is a computer-implemented system for a shift actuator assembly of a continuously variable transmission having a ball-planetary variator (CVP) having a plurality of tiltable balls coupled to a first carrier member and a second carrier members, wherein the first carrier member is adapted to rotate with respect to the second carrier member, the shift actuator assembly comprising: a hydraulic actuator operably coupled to the second carrier member, the hydraulic actuator comprising a first electronic proportional valve and a second electronic proportional valve configured to control the relative position of the second carrier member with respect to the first carrier member, the computer-implemented system comprising: a digital processing device comprising an operating system configured to perform executable instructions and a memory device; a computer program including instructions executable by the digital processing device to create an application comprising a software module configured to manage the first electronic proportional valve and the second electronic proportional valve; a plurality of sensors comprising: a first carrier position sensor, a second carrier position sensor, a first electronic pressure sensor in hydraulic communication with the first electronic proportional valve, a second electronic pressure sensor in hydraulic communication with the second electronic proportional valve, a CVP input speed sensor, a CVP output speed sensor and a CVP speed ratio sensor; the plurality of sensors configured to monitor continuously variable transmission parameters comprising: a first carrier position, a second carrier position, a first pressure in hydraulic communication with the first electronic proportional valve, a second pressure in hydraulic communication with the second electronic proportional valve, a CVP input speed , a CVP output speed and a CVP speed ratio; wherein the software module receives data from the plurality of sensors and executes instructions to manage a controlled activation of the first and second electronic proportional valves; wherein the software module commands the first electronic proportional valve to deliver the first hydraulic pressure and commands the second electronic proportional valve to deliver the second hydraulic pressure; wherein the software module monitors the CVP (input/output) speed ratio; and wherein the software module commands a change in the first carrier position with respect to the second carrier position of the CVP based at least in part on the speed ratio of the CVP.

In some embodiments of the computer implemented system, the CVP speed ratio is determined based at least in part on a CVP output speed sensor.

In some embodiments of the computer implemented system, the first carrier position with respect to the second carrier position is indicative of the CVP speed ratio.

Provided herein is a hydraulic actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the hydraulic actuator assembly comprising: a manifold body adapted to receive a pressurized fluid; a solenoid valve coupled to the manifold body; and a spool housed and supported in the manifold body; wherein the manifold body is configured to route the pressurized fluid to the solenoid valve and the spool; and wherein the manifold body is hydraulically coupled to at least one carrier member.

In some embodiments, the hydraulic actuator comprises a first pressure cylinder, a second pressure cylinder, and a control piston, wherein the first pressure cylinder and the second pressure cylinder are arranged to exert a fluid pressure on each side of the control piston.

In some embodiments of the hydraulic actuator, the control piston is operably coupled to at least one carrier member.

In some embodiments of the hydraulic actuator, a movement of the control piston corresponds to a rotation of the carrier member.

In some embodiments of the hydraulic actuator, a plurality of drain channels are in fluid communication with the spool and the solenoid valve.

Provided herein is a hydraulic actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the hydraulic actuator assembly comprising: a manifold body adapted to receive a pressurized fluid; a first solenoid valve coupled to the manifold body; and a second solenoid valve coupled to the manifold body; wherein the manifold body is adapted to route the pressurized fluid to the first solenoid valve and the second solenoid valve; and wherein the manifold body is provided with a first outlet port and a second outlet port, the first outlet port in fluid communication with the first solenoid valve, the second output port in fluid communication with the second solenoid valve; and wherein the first and second outlet ports are hydraulically coupled to at least one carrier member.

In some embodiments of the hydraulic actuator, a first pressure cylinder, a second pressure cylinder, and a control piston are arranged to exert a fluid pressure on each side of the control piston.

In some embodiments of the hydraulic actuator, the control piston is operably coupled to at least one carrier member.

In some embodiments of the hydraulic actuator, a movement of the control piston corresponds to a rotation of the carrier member.

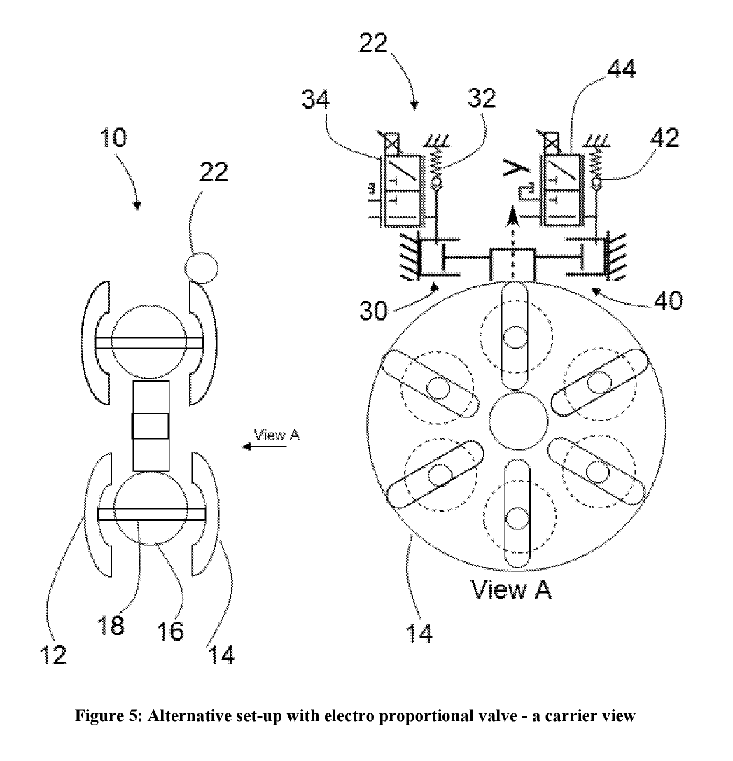

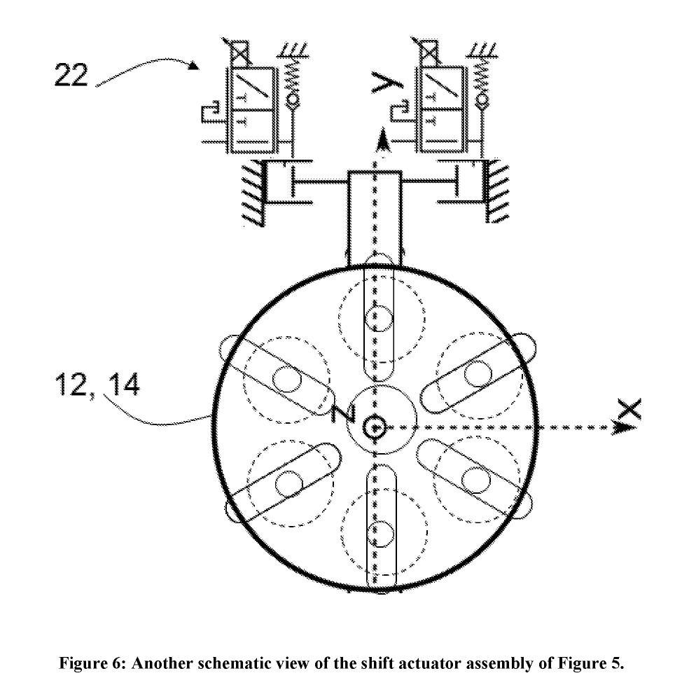

Moving now to FIGS. 5 and 6, in some embodiments, a shift actuator assembly 10 is used on a continuously variable transmission (CVT) having a first carrier member 12 and a second carrier member 14 arranged to provide radial and axial support for a number of balls 16, each having a tiltable axis of rotation 18. The first carrier member 12 and the second carrier member 14 are adapted to rotate with respect to each other. A relative rotation of the first carrier member 12 with respect to the second carrier member 14, or vice versa, corresponds to a shift in the operating condition of the CVT. The shift actuator assembly 10 is optionally provided with a hydraulic actuator 22 operably coupled to the second carrier member 14.

In some embodiments, the hydraulic actuator 22 includes a first piston-cylinder assembly 30 operably coupled to the second carrier member 14. The first piston-cylinder assembly 30 is configured whereby the cylinder is adapted to receive a pressurized hydraulic fluid to impart a change in position to the piston. A change in position of the piston corresponds to a change in the rotational position of the second carrier member 14. In some embodiments, the first piston-cylinder assembly 30 is hydraulically coupled to a first pressure relief valve 32. The first piston-cylinder assembly 30 is hydraulically coupled to a first proportional valve 34. In some embodiments, the first proportional valve 34 is electronically controlled. The first proportional valve 34 is used to control a pressurized fluid entering the first piston-cylinder assembly 30 and thereby control the rotational position of the second carrier member 14.

In some embodiments, the hydraulic actuator 22 includes a second piston-cylinder assembly 40 operably coupled to the second carrier member 14. The second piston-cylinder assembly 40 is configured whereby the cylinder is adapted to receive a pressurized hydraulic fluid to impart a change in position to the piston. A change in position of the piston corresponds to a change in the rotational position of the second carrier member 14. In some embodiments, the second piston-cylinder assembly 40 is hydraulically coupled to a second pressure relief valve 42. The second piston-cylinder assembly 40 is hydraulically coupled to a second proportional valve 44. In some embodiments, the second proportional valve 44 is electronically controlled. The second proportional valve 44 is used to control a pressurized fluid entering the second piston-cylinder assembly 40 and thereby control the rotational position of the second carrier member 14.

During operation of the CVT, the hydraulic actuator 22 is controlled through an electronic controller to adjust the operating condition of the CVT. For example, the hydraulic actuator 22 is provided with electronic pressure sensors coupled to the first piston-cylinder assembly 30 and the second piston-cylinder assembly 40, respectively. The pressure readings are used to indicate the current operating condition of the CVT. Signals are commanded or sent from the electronic controller to adjust the first proportional valve 34 and the second proportional valve 44. The first pressure relief valve 32 and the second pressure relief valve 42 are adjusted to provide an upper limit to the pressure inside the first piston-cylinder assembly 30 and the second piston-cylinder assembly 40, respectively, and thereby limit the operating torque in the CVT.

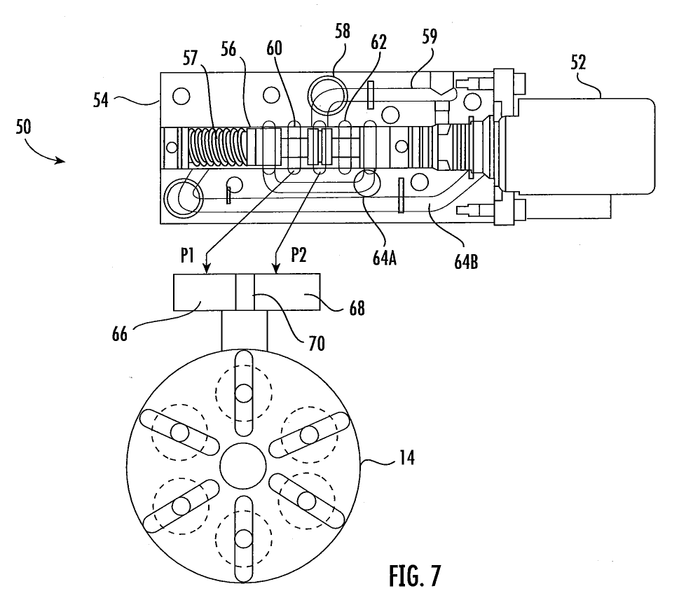

Turning now to FIG. 7, in some embodiments, a hydraulic actuator 50 may include a solenoid valve 52 operably coupled to a manifold body 54. The solenoid valve 52 is a well-known electromechanically controlled valve that is in electronic communication with a transmission control system. The manifold body 54 is configured to house and support a spool 56. The spool 56 is adapted to move axially along the interior of the manifold body 54. In other words, the spool is adapted to move left and right with respect to the plane of the page of FIG. 7. The spool 56 is a generally cylindrical body have a first end, a middle portion, and a second end. The spool 56 is optionally formed with a first neck portion positioned between the middle portion and the first end. The spool 56 is optionally formed with a second neck portion positioned between the middle portion and the second end. Axial movement of the spool 56 is reacted by a spring 57. The spring 57 is positioned on one end of the spool 56. It should be noted, that it may be desirable for some embodiments of the hydraulic actuator 50 to position the spring 57 at a different location along the spool 56. The manifold body 54 is configured to receive a pressurized fluid at an inlet port 58. A channel 59 connects the inlet port 58 to the spool 56. The manifold body 54 is configured with a first outlet port 60 and a second outlet port 62. During operation of the hydraulic actuator 50, a pressurized fluid enters the manifold body 54 and is delivered to the spool 56. The axial position of the spool 56 controls the flow of pressurized fluid to the first outlet port 60 and the second outlet port 62. The axial position of the spool 56 is controlled by the solenoid valve 52. The solenoid valve 52 receives pressurized fluid through a channel 59. A number of drain channels 64 is provided in the manifold body 54. The drain channels 64 are hydraulically coupled to the solenoid valve 52 and the spool 56. In some embodiments, the drain channels 64 dump fluid into a transmission sump.

In some embodiments, the first outlet port 60 is hydraulically coupled to a first cylinder 66. The second outlet port 62 is hydraulically coupled to a second cylinder 68. The first cylinder 66 and the second cylinders 68 are arranged to exert pressure on a piston 70. The piston 70 is operably coupled to a carrier 14. It should be noted, that the layout of the first cylinder 66, the second cylinders 68 and piston 70 is sometimes referred to as a double-acting-piston configuration whereby a difference in pressure between the first cylinder 66 and the second cylinder 68 will have a resulting force in the direction of the higher pressure and thereby move the piston 70 in the direction of the resulting force.

During operation of the CVT, the speed ratio is controlled by changing the fluid pressure in the first cylinder 66 and the second cylinders 68. The fluid pressure is controlled by solenoid valve 52 and spool 56.

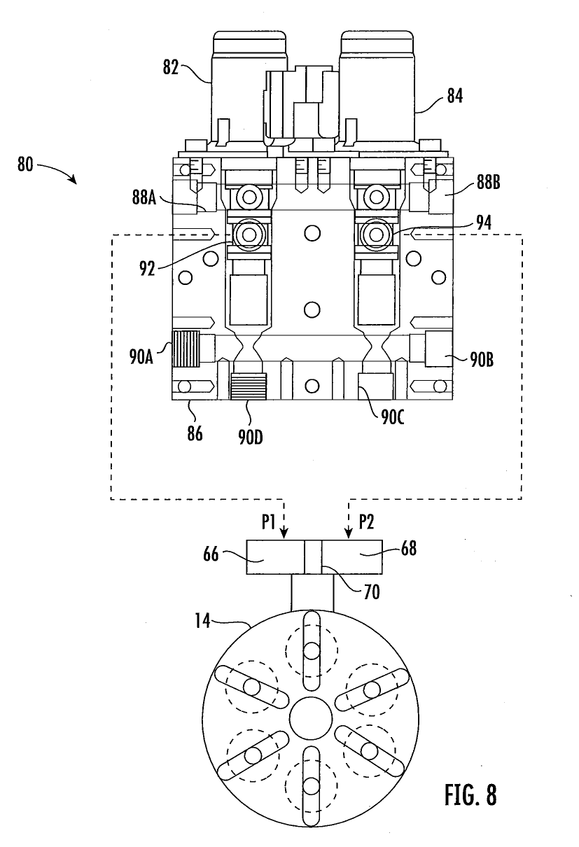

Referring now to FIG. 8, in some embodiments, a hydraulic actuator 80 includes a first solenoid valve 82 and a second solenoid valve 84 supported by a manifold body 86. The manifold body 86 is provided with a number of inlet openings 88 that supply a pressurized fluid to the first solenoid valve 82 and the second solenoid valve 84. The manifold body 86 is provided with a number of drain channels 90 are adapted to route fluid out of the hydraulic actuator 80 and to a transmission sump, for example. The manifold body 86 is provided with a first outlet opening 92 that is in hydraulic communication with the first solenoid valve 82. Stated differently, the first solenoid valve 82 acts to control the pressure of the working fluid at the first outlet opening 92. The manifold body 86 is provided with a second outlet opening 94 that is in hydraulic communication with the second solenoid valve 82. That is, the second solenoid valve 82 acts to control the pressure of the working fluid at the second outlet opening 94. The first outlet opening 92 is hydraulically coupled to the first cylinder 66. The second outlet opening 94 is hydraulically coupled to the second cylinder 68. As previously stated, a pressure differential between the first cylinder 66 and the second cylinder 68 act on the piston 70 to thereby rotate the carrier 14 and facilitate a change in speed ratio during operation of the CVT.

Torque Damping

Provided here in is a shift actuator assembly for a continuously variable planetary transmission having a plurality of tiltable balls coupled to a carrier assembly, the carrier assembly having a first carrier member and a second carrier member, the first carrier member adapted to rotate with respect to the second carrier member, the shift actuator assembly comprising: a hydraulic actuator operably coupled to at least one carrier member, the hydraulic actuator comprising a first electronic proportional valve, the first electronic proportional valve configured to control the relative position of the second carrier member with respect to the first carrier member; and a damping device operably coupled to at least one carrier member, the damping device configured to adjust the reaction torque on the at least one carrier member during operation of the transmission.

In some embodiments of the hydraulic actuator, the damping device comprises a first spring, the first spring coupled to the carrier member and to a grounded member.

In some embodiments of the hydraulic actuator, the damping device further comprises a second spring coupled to the carrier member, the second spring coupled to the first spring, the first spring having a first spring rate, the second spring having a second spring rate.

In some embodiments of the hydraulic actuator, the damping device comprises a spring with an adjustable pre-load.

Provided herein is a computer-implemented system for a shift actuator assembly of a continuously variable transmission having a ball-planetary variator (CVP) having a plurality of tiltable balls coupled to a carrier assembly, the carrier assembly having a first carrier member and a second carrier member, wherein the first carrier member is adapted to rotate with respect to the second carrier member, the system comprising: a hydraulic actuator operably coupled to at least one carrier member, the hydraulic actuator comprising at least one electronic valve configured to control the relative position of the second carrier member with respect to the first carrier member, the computer-implemented system comprising: a digital processing device comprising an operating system configured to perform executable instructions and a memory device; a computer program including instructions executable by the digital processing device to create an application comprising a software module configured to manage the at least one electronic valve; a plurality of sensors comprising: a first carrier position sensor, a second carrier position sensor, a first electronic pressure sensor in hydraulic communication with the first electronic proportional valve, a second electronic pressure sensor in hydraulic communication with the second electronic proportional valve, a CVP input speed sensor, a CVP output speed sensor and a CVP speed ratio sensor; the plurality of sensors configured to monitor continuously variable transmission parameters comprising: a first carrier position, a second carrier position, a first pressure in hydraulic communication with the first electronic proportional valve, a second pressure in hydraulic communication with the second electronic proportional valve, a CVP input speed; and a CVP output speed, wherein the software module receives data from the plurality of sensors and executes instructions to manage a fluid supply pressure to the at least one electronic valve; wherein the software module commands the at least one electronic valve to deliver a commanded pressure; wherein the software module monitors a CVP speed ratio; and wherein the software module commands a change in the first carrier position with respect to the second carrier position of the CVP based at least in part on the speed ratio of the CVP.

During vehicle operation, the CVT may encounter dynamic fluctuation in torque transmitted through the CVP. In some instances, the torque fluctuation is generated by the vehicle running over an object and thereby transmitting a reaction through the drive wheels to the CVP. In some instances, the torque fluctuation is generated by the torque input to the CVP from, for example, the engine. A control system for the CVP is configured to account for, and react to, these dynamic events. During operation of the CVP depicted in FIGS. 1-3, torque transmitted via the balls is reacted by the carrier assembly. As stated previously, the relative rotation of the first carrier member with respect to the second carrier members facilitates shifting of the CVP.

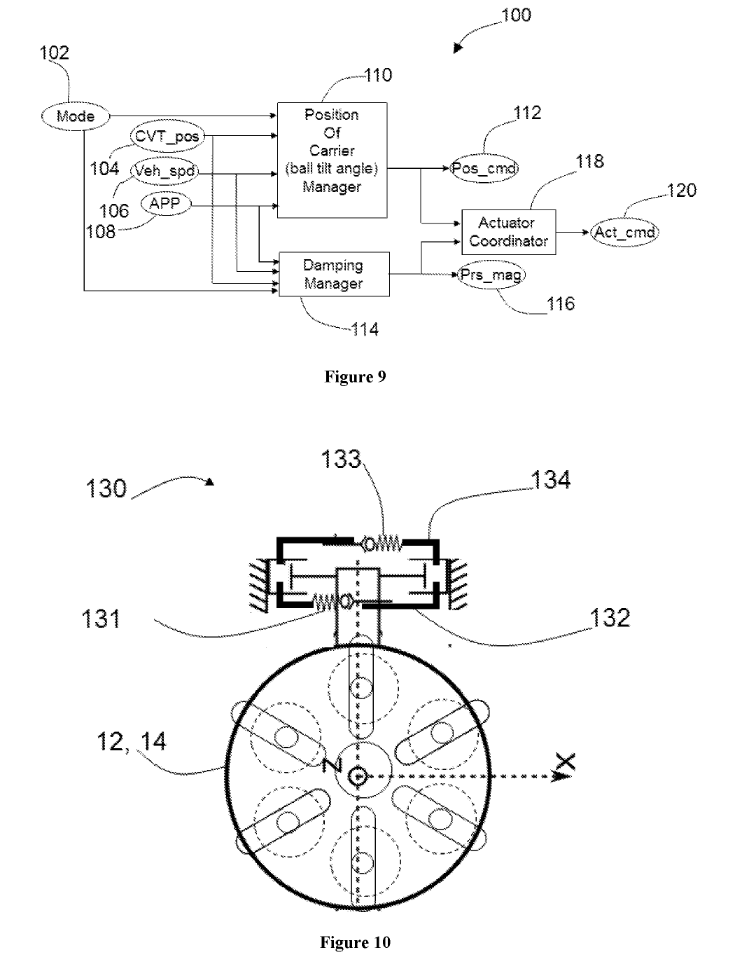

Turning now to FIG. 9, in some embodiments, a transmission control system 100 is adapted to receive a number of input signals. For example, a mode signal 102 is indicative of the current operating mode of the transmission. A carrier position signal 104 is indicative of the rotational position of the first or second carrier members. A vehicle speed signal 106 is indicative of the current speed of the vehicle (not shown). An accelerator pedal position signal 108 is indicative of the current position of the accelerator pedal (not shown). In some embodiments, the signals originate from sensors mounted on transmission or vehicle components. In some embodiments, the accelerator pedal position signal 108 is replaced with a throttle position signal that is indicative of an engine throttle position (not shown).

In some embodiments, the transmission control system 100 includes a control sub-module 110 that receives the mode signal 102, the carrier position signal 104, the vehicle speed signal 106, and the accelerator pedal position signal 108. The control sub-module 110 is programmed to determine a commanded carrier position signal 112. It should be noted that the control sub-module 110 optionally includes a variety of methods to determine a desired carrier position. For example, the desired carrier position is optionally based at least in part on a desired operating speed ratio, a desired operating torque, among others. The transmission control system 100 optionally includes a damping control sub-module 114 that runs in parallel with the control sub-module 110. The damping control sub-module 114 is adapted to receive the mode signal 102, the carrier position signal 104, the vehicle speed signal 106, and the accelerator pedal position signal 108. The damping control sub-module 114 is programmed to determine a commanded hydraulic pressure magnitude 116. The hydraulic pressure is exerted on the carrier assembly to facilitate shifting as discussed previously. The transmission control system 100 includes an actuator coordinator sub-module 118 that receives the commanded carrier position signal 112 and the commanded hydraulic pressure magnitude 116. The actuator coordinator sub-module 118 is programmed to determine an actuator command signal 120 based at least in part on the commanded carrier position signal 112 and the commanded hydraulic pressure magnitude 116. In some embodiments, the actuator command signal 120 is a command signal sent to the solenoid valve 52, for example. In some embodiments, the commanded hydraulic pressure magnitude 116 is used as a control signal to determine the magnitude of the fluid pressure supplied to the inlet port 58 of the hydraulic actuator 50, for example.

During operation of the CVT, the transmission control system 100 controls the transmission speed ratio and dynamic stiffness/damping characteristics. For example, when a commanded hydraulic pressure magnitude is high, the holding force on the piston 70, for example, is high, and the carrier 14 is stiffly held in position, or stated differently, the carrier 14 is heavily damped for torque spikes. A differential pressure applied to the first cylinder 66 and the second cylinder 68 moves the piston 70. When no change in speed ratio is desired, the differential pressure applied to the first cylinder 66 and the second 68 is near zero, but the commanded hydraulic pressure magnitude may still be high. Therefore, a dynamic torque input to the transmission system would be resisted by the holding force applied to the piston 70. When a commanded hydraulic pressure magnitude is low, the holding force on the piston 70 is low, and the carrier 14 is softly held in position, or stated differently, the carrier 14 is lightly damped for torque input. Therefore, a dynamic torque input may change the position of the carrier 14 if the torque input is large enough to overcome the magnitude of the holding force. It may be desirable to be lightly damped when a fast shift event is desired. In some embodiments, it is desirable to be heavily damped when operating a condition where precise and steady control of the speed ratio is desired. The damping control sub-module 114 is optionally calibrated or programmed to map conditions whereby light and heavy damping is desirable during operation of the CVT.

Provided herein is a computer-implemented system for a shift actuator assembly of a continuously variable transmission having a ball-planetary variator (CVP) having a plurality of tiltable balls coupled to a carrier assembly, the carrier assembly having a first carrier member and a second carrier member, wherein the first carrier member is adapted to rotate with respect to the second carrier member, the system comprising: a hydraulic actuator operably coupled to at least one carrier member, the hydraulic actuator comprising an electronic valve configured to control the relative position of the second carrier member with respect to the first carrier member, the computer-implemented system comprising: a digital processing device comprising an operating system configured to perform executable instructions and a memory device; a computer program comprising the instructions executable by the digital processing device to create an application comprising a software module configured to manage the electronic valve; a plurality of sensors comprising: a first carrier position sensor, a second carrier position sensor, an electronic pressure sensor in hydraulic communication with the electronic valve, a CVP input speed sensor, a CVP input speed sensor and a CVP output speed sensor; the plurality of sensors configured to monitor continuously variable transmission parameters comprising: a first carrier position, a second carrier position, a pressure in hydraulic communication with the electronic valve, a CVP input speed; and a CVP output speed, wherein the software module receives data from the plurality of sensors and executes the instructions to control a fluid supply pressure to the electronic valve; wherein the software module commands the electronic valve to operate at the pressure; wherein the software module monitors a CVP speed ratio based on the CVP input speed and the CVP output speed; and wherein the software module commands a change in the first carrier position with respect to the second carrier position of the CVP based at least in part on the speed ratio of the CVP.

In some embodiments, the software module further comprises a damping control sub-module configured to control the fluid supply pressure based at least in part on a desired damping of the CVP. In some embodiments the desired damping of the CVP is based at least in part on a torque input to the CVP. In some embodiments, the software module further comprises a calibration table storing values of a commanded hydraulic pressure based at least in part on the torque input.

Passing now to FIG. 10, in some embodiments, the hydraulic actuator 130 includes a first check valve 131 and a first fluid coupling 132, for example a tube, connecting the first cylinder to the second cylinder. The hydraulic actuator 130 includes a second check valve 133 and a second fluid coupling 134 connecting the first cylinder to the second cylinder. The first check valve 131 and the second check valve 133 are configured to regulate maximum allowable pressure differential between the first cylinder and the second cylinder. During operation of the transmission, a pressure differential between the first cylinder to the second cylinder will facilitate a rotation of the carrier 14 with respect to the carrier 12, or vice versa, to thereby change the speed ratio of the transmission. Operating torque transmitted through the transmission is reacted by the carriers 12, 14 and is thereby transmitted to the actuator 130. The torque is reacted by the fluid pressure exerted on the pistons by the cylinders. The first check valve 131 and the second check valve 133 provide a hydraulic means to limit the torque transmitted by the transmission by regulating the reaction torque on the carriers. When reaction torque overcomes the upper threshold provided by the first check valve 131 and the second check valve 133, the carrier 14 will rotate with respect to the carrier 12, or vice versa, and thereby change the speed ratio of the transmission until a condition is achieved to lower the reaction torque below the limit set forth by the first check valve 131 and the second check valve 133. It should be noted, that the hydraulic actuator 130 may be provided with a number of hydraulic control valves of the type disclosed herein. For description purposes and clarity, other control valves that may be in hydraulic communication with the first cylinder and the second cylinders are not shown.

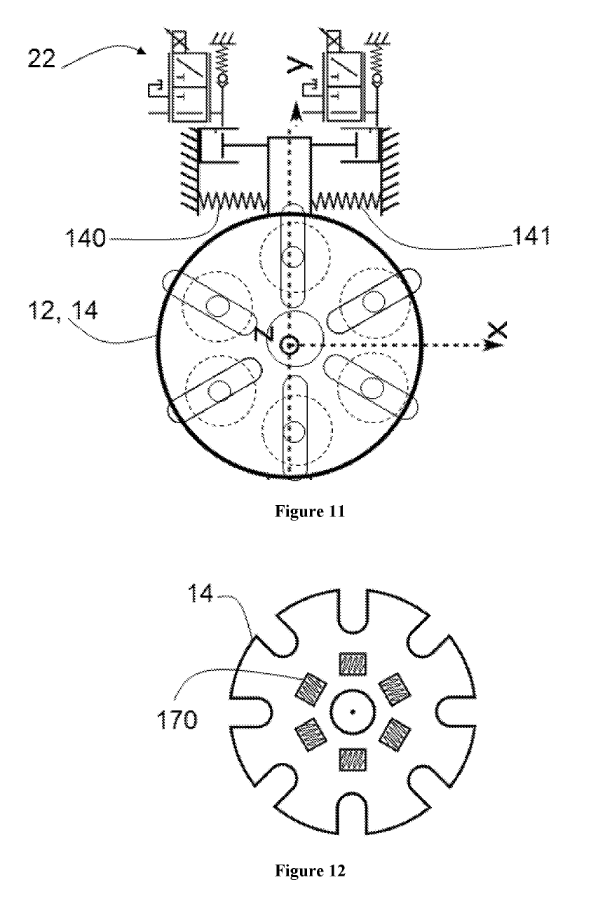

Referring now to FIG. 11, in some embodiments, the hydraulic actuator 22 includes a first centering spring 140 and a second centering spring 141. The first centering spring 140 and the second centering spring 141 are arranged to provide opposing force on the carrier member 14 and/or the carrier member 12. The first centering spring 140 and the second centering spring 141 apply force such that the carrier members 14, 12 return to a neutral position when there is a loss of fluid pressure. The first centering spring 140 and the second centering spring 141 optionally include variable rate springs in order to tailor speed ratio responsiveness to various application requirements.

Turning now to FIG. 12, in some embodiments, the carrier 14 are configured to house and couple a number of springs 170. In some embodiments, the springs 170 are grounded to a non-rotating component of the transmission. In some embodiments, the springs 170 are variable rate springs. In other embodiments, the springs 170 are replaced with a torsion spring (not shown).

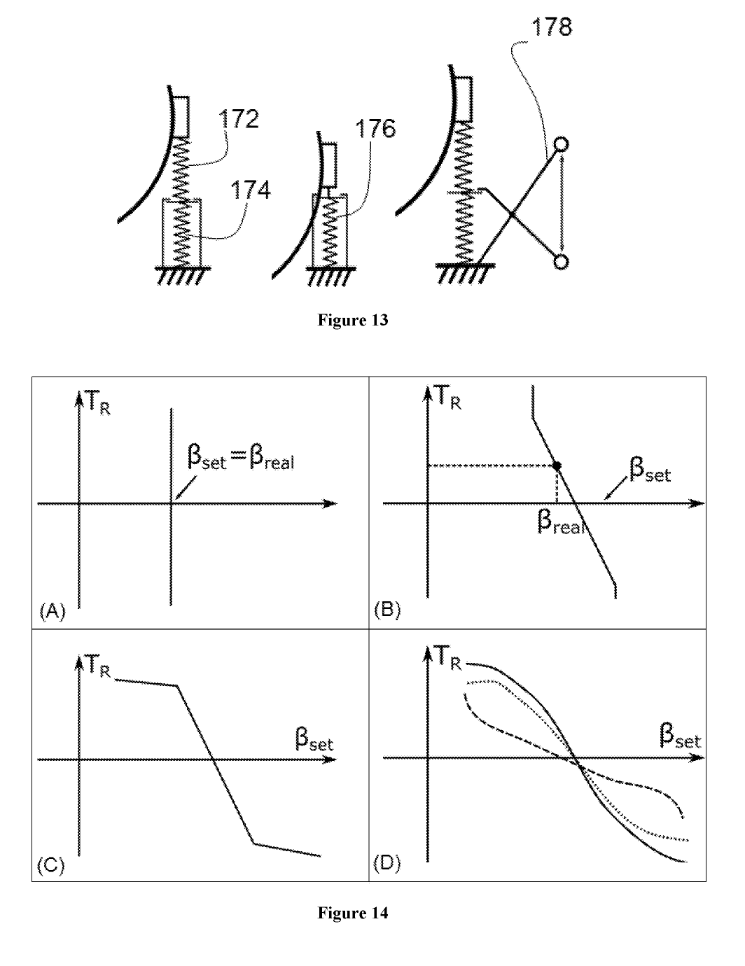

Referring now to FIG. 13, a variety of arrangements are considered to provide a passive damping means to the carrier 14. A system is optionally configured to include a first spring 172 having a first spring rate. The first spring 172 is optionally coupled to a second spring 174 having a second spring rate. In other embodiments, a system has a pre-stressed spring 176 coupled to the carrier 14. In yet other embodiments, a scissor mechanism 178 is provided that can adjust the pre-load of the system.

Referring to FIG. 14, charts (A) through (D) depict relationships between the carrier position (β) and carrier reaction torque (T_{R}). Chart (A) depicts the relationship in a rigid transmission control system. Chart (B) depicts the relationship for a system having a passive damping means with a pre-stressed spring. Chart (C) depicts the relationship for a system having a passive damping means with dual rate or variable rate springs. Chart (D) depicts the relationship for a system having a combination of active variable damping means or a combination of variable rate springs, pre-stressed springs, and passive damping.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-29. (canceled)

30. A method of controlling a CVP ratio of a continuously variable planetary transmission having a plurality of tiltable balls coupled to a first carrier member and a second carrier member, the first carrier member adapted to rotate with respect to the second carrier member, the method comprising:
providing a hydraulic actuator operably coupled to at least one carrier member, the hydraulic actuator comprising a first electronic valve configured to control the relative position of the second carrier member with respect to the first carrier member;
receiving a plurality of signals indicative of a first carrier position, a second carrier position, a first pressure in hydraulic communication with the first electronic valve, a CVP input speed, and a CVP output speed;
commanding the first electronic valve to operate at a fluid supply pressure;
monitoring a CVP ratio based on the CVP input speed and the CVP output speed; and
changing in the first carrier position with respect to the second carrier position of the CVP based at least in part on the ratio of the CVP.

31. The method of claim 30, wherein the fluid supply pressure is based at least in part on a desired damping of the CVP.

32. The method of claim 31, wherein the desired damping of the CVP is based at least in part on a torque input to the CVP.

33. The method of claim 30, wherein the fluid supply pressure is determined using a calibration table of commanded hydraulic pressure based at least in part on the torque input to the CVP.

34. A method of controlling a CVP ratio of a continuously variable planetary transmission having a plurality of tiltable balls coupled to a first carrier member and a second carrier member, the first carrier member adapted to rotate with respect to the second carrier member, the method comprising:
providing a hydraulic actuator operably coupled to the second carrier member, the hydraulic actuator comprising a first electronic valve and a second electronic valve configured to control the relative position of the second carrier member with respect to the first carrier member;
receiving a plurality of signals indicative of a first carrier position, a second carrier position, a first pressure in hydraulic communication with the first electronic valve, a second pressure in hydraulic communication with the second electronic valve, a CVP input speed, and a CVP output speed;
commanding the first electronic valve to operate at a first pressure;
commanding the second electronic valve to operate at a second pressure;
monitoring a CVP ratio based on the CVP input speed and the CVP output speed; and
changing the first carrier position with respect to the second carrier position of the CVP based at least in part on the ratio of the CVP.

35. The method of claim 34, wherein the CVP ratio is determined based at least in part on the CVP output speed.

36. The method of claim 34, wherein the first carrier position with respect to the second carrier position is indicative of the CVP ratio.

37. The method of claim 34, wherein the first and/or second electronic valves are electronic proportional valves.
